(19) United States
(12) Patent Application Publication
(10) Pub. No.: US 2002/0048404 A1
(43) Pub. Date: Apr. 25, 2002

(54) Apparatus and method for determining spatial orientation

(76) Inventors: Christer Fahraeus, Lund (SE); Stefan Burstrom, Lund (SE); Erik Persson, Lund (SE); Mats Petter Pettersson, Lund (SE)

Correspondence Address: BIRCH STEWART KOLASCH & BIRCH, PO BOX 747, FALLS CHURCH, VA, 22040-0747, US

(21) Appl. No.: 09/812,902

(22) Filed: Mar. 21, 2001

Related U.S. Application Data
(60) Provisional application No. 60/207,844, filed on May 30, 2000.

(30) Foreign Application Priority Data
Mar. 21, 2000 (SE) 0000951-4

(51) Int. Cl. G06K 9/00

(52) U.S. Cl. 382/188

(57) ABSTRACT

A system and a corresponding method for determining a spatial relationship between a surface having a predetermined pattern and an apparatus are disclosed. A portion of the surface may be imaged and compared with the predetermined pattern. The comparison produces at least one reference measurement that may be used to determine a spatial relationship expressed in at least parameters that define an orientation of the surface. By using knowledge of the predetermined pattern together with an algebraic model of the image formation by the apparatus, a numerical adaptation can be performed. Parameters obtained from the adaptation can then be used to calculate the spatial relationship between the apparatus and the surface in terms of, for example, a distance between the apparatus and the surface or an angle between the surface and an axis extending through the apparatus.

### CROSS REFERENCE TO RELATED APPLICATIONS

This application claims priority benefits based on Swedish Patent Application No. 0000951-4, filed Mar. 21, 2000, and U.S. Provisional Application 60/207,844, filed May 30, 2000, the technical disclosures of each are hereby incorporated herein by reference.

### FIELD OF INVENTION

The present invention relates to pattern recognition and detection. Specifically, the present invention relates to methods and apparatuses for determining a spatial relationship between an input apparatus and a surface.

### BACKGROUND OF THE INVENTION

To input information into computerized equipment, a pointing device, such as a computer mouse, or digitizing pen may be used. A feature common to these types of devices is that in most cases they supply only information directly related to two spatial dimensions.

A typical computer mouse, for example, moves on top of a plane surface, and coded information about the movement of the mouse is supplied to a computer via mechanical rolling arrangements, electro-mechanical circuits and coding logic. Similarly, a digitizing pen designed with an optical or electric sensor in its tip, makes contact with a digitizing tablet. The contact between the pen and the surface generates analog or digital signals that are then interpreted by a computer depending upon the contact position between the pen tip and the tablet.

According to the known art, digitized pen applications may be relatively complicated electrical arrangements in the pointing device and a base intended specifically for the pointing device. An example of this known art is described in U.S. Pat. No. 5,198,623. This patent discloses a method in a digitizing arrangement for establishing the tilting angle of a pen used in the application. The pen includes a coil that when placed in electrical contact with an array of electrical conductors in a digitizing tablet, generates electrical pulses. The electrical pulses are then analyzed, producing a measurement of the pen tilt in relation to the surface of the tablet.

The arrangements and the method disclosed in U.S. Pat. No. 5,198,623 include a large number of electrical components, unnecessarily increasing the cost and efficiency of solutions derived. Further, the disclosed device also makes it necessary for the pen to interact with a special digitizing tablet. A user is therefore tied to the specific combination of pen and base disclosed.

A method and apparatus for recording data from a sheet are disclosed in U.S. Pat. No. 5,101,096. Data in the form of optical recording dots arranged in perpendicular lines and columns are detected by a two dimensional (CCD) optical line sensor. An inclination angle is calculated between the optical recording lines and the optical line sensor. The inclination angle is then used to restore the detected data.

The method and apparatus disclosed in U.S. Pat. No. 5,101,096 are directed to compensating for a misalignment between the optical recordings arranged in straight lines and the CCD-detector elements arranged in similar lines and columns. This patent and similar prior art references, however, does not disclose calculating misalignment due to the lines of the recordings and the detector not being parallel.

### SUMMARY OF A FEW ASPECTS OF THE INVENTION

Systems and methods consistent with the present invention may reduce the number of electrical components necessary to determine spatial relationship between a surface and a detecting apparatus. Systems and methods consistent with the present invention may also provide a detectable image pattern that may be placed on a surface for the apparatus to analyze.

According to a first aspect of the invention, an apparatus may be provided for determining a three-dimensional spatial relationship between a principle surface having a predetermined pattern. A part of the surface may be imaged using a sensor, after which the image may be compared with the predetermined pattern. The comparison produces at least one reference measurement, by means of which it is possible to determine the spatial relationship expressed in at least the parameters which define the orientation of the surface. By using knowledge of the predetermined pattern together with an algebraic model of the image detected by the sensor, a numerical adaptation can performed. Parameters obtained from the adaptation can then be used to calculate the spatial relationship between the apparatus and the surface in terms of, for example, a distance between the sensor and the surface or an angle between the principle surface and an axis extending through the apparatus.

One effect of the invention may be therefore that, by comparing a predetermined pattern with an image of the pattern, an assessment of, for example, the rotation, tilt and skew of the apparatus as well as the distance between the apparatus and the patterned surface can be obtained. The orientation of a device such as a pen with respect to the pattern on the surface may be expressed using three parameters: rotation, tilt and skew. The skew may be defined as the angle of rotation of the pen around its rotational axis. The tilt angle may be the angle the pen extends with respect to a normal vector to the surface and the rotation is the angle of rotation of the pen with respect to the normal vector. A zero tilt may imply that the rotation is equal to the skew.

Some embodiments of the invention may permit pattern detection without the use of complicated electrical arrangements. Only processing means, that may be suitably programmed by software, are required in order to obtain the desired measurement of the spatial positional relationship between the apparatus and the surface.

According to a second aspect of the present invention, an apparatus and a method for position determination are disclosed. An image may be produced of one partial surface or a number of partial surfaces on a principle surface that may be provided with a position-coding pattern. Image-processing may be performed on this image. The process may include locating a predetermined plurality of symbols in the image and determining the value of each of these predetermined symbols. The symbols may include a raster point and at least one marking, the raster point forming part of a raster that extends over the surface, and the value of each symbol being indicated by the position of the marking in relation to a raster point.

The position-coding pattern that has been imaged maybe separated into a first position code for a first coordinate for the partial surface and a second position code for a second coordinate for the partial surface. The first coordinate may be then calculated by means of the first position code, and the second coordinate may calculated using the second position code. A third coordinate may be calculated by comparing the imaged part of the pattern with the predetermined pattern to obtain at least one reference measurement, which depends on the orientation of the surface. Reference measurements may determine the spatial relationship expressed in at least the parameters that define the orientation of the surface. This spatial relationship may then determines the third coordinate.

The first two coordinates may be obtained by interpreting the symbols, where displacements of the markings forming part of the symbols in relation to a normal position contain information in the form of the two-dimensional positions on the surface read. The third coordinate may be calculated by the information obtained from the distortion of the known pattern that occurs on image formation by the apparatus, the image formed being for the most part affected by the relative spatial positional relationship between the reading apparatus and the patterned surface. For example, the pattern in the image formed may be distorted in perspective when reading is performed in a direction that does not lie in the normal direction in relation to the surface. Moreover, the imaged pattern may be changed in terms of scale when reading may be performed with the apparatus located at a greater distance from the surface.

In a corresponding manner to that in the first aspect described above, a reference measurement can be used in order to calculate the three-dimensional spatial relationship between the sensor and the surface. With this, it may be possible to determine, for example, a distance between the sensor and the surface or an angle between the surface and an axis extending through the sensor. These measurements can then be used in a mathematically simple manner for determining the third coordinate.

According to this aspect of the invention, a pointing device can therefore be produced which can supply coordinates which represent three dimensions to, for example, a computer. The application in the computer using the three-dimensional positional information, including rotation, tilt and skew can of course be of different types. Particularly interesting are applications relating to calligraphy. Calligraphy applications may include those applications of drawing/writing where the device is used as a brush. In these applications the rotation, tilt and skew of the device may be used to represent, on a display or when printing, a digitized trail made with the device. If combined with an assumed or selected shape of a virtual brush, such a trail may on screen or in print, have the characteristics of a trail made manually by a person using a brush, i.e. a trail with varying widths. It is also possible to utilize, e.g., the information regarding the distance between the pen and the surface to represent a color density of the trail when presenting it on a screen or on paper, thus further enhancing the likeness with a manually painted trail.

Moreover, general applications relating to biometrics, i.e., measuring of the movement of, e.g., a hand which holds and moves the device. Such an application is signature recognition.

The invention may be implemented in an apparatus without moving parts and without the use of complicated, expensive bases in the form of digitizing tablets full of electronics. An apparatus according to the invention may be produced using optical components and an image-processing processor that reads a pattern on, for example, a sheet of paper, the complexity of which in terms of physical construction may be reduced in comparison with a digitizing tablet.

The foregoing summarizes only a few aspects of the invention and is not intended to be reflective of the full scope of the invention as claimed. Additional features and advantages of the invention are set forth in the following description, may be apparent from the description, or may be learned by practicing the invention. Moreover, both the foregoing general description and the following detailed description are exemplary and explanatory and are intended to provide further explanation of the invention as claimed.

### BRIEF DESCRIPTION OF THE DRAWINGS

The accompanying drawings, which are incorporated in and constitute a part of this specification, illustrate one embodiment of the invention and, together with the description, serve to explain the objects, advantages, and principles of the invention. In the drawings:

FIG. 1 shows schematically an embodiment of a product provided with a position-coding pattern in accordance with the invention;

FIGS. 2a-2d show schematically how the symbols can be designed in an embodiment of the invention;

FIG. 3 shows schematically an example of 4×4 symbols used to code a position;

FIG. 4 shows schematically an apparatus according to the present invention used for position determination in three dimensions;

FIG. 5 shows schematically how a pattern on a surface may be imaged in an apparatus according to the invention; and

FIG. 6 shows how a pattern may be distorted in an image formed in an apparatus according to the invention.

### DESCRIPTION OF PREFERRED EMBODIMENTS

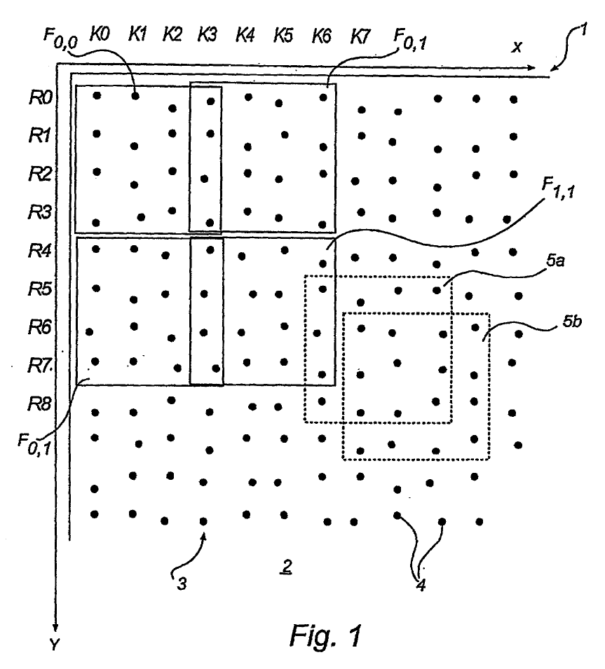

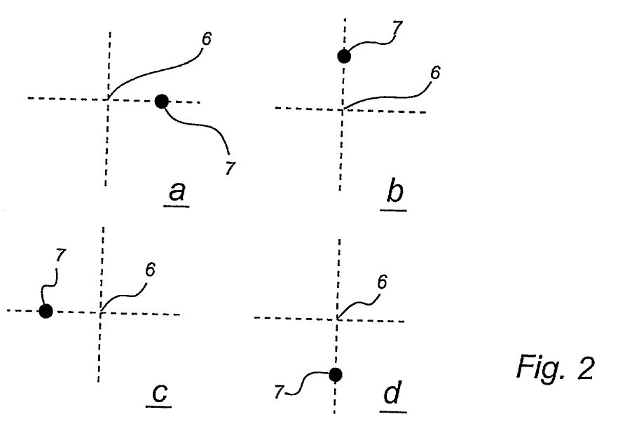

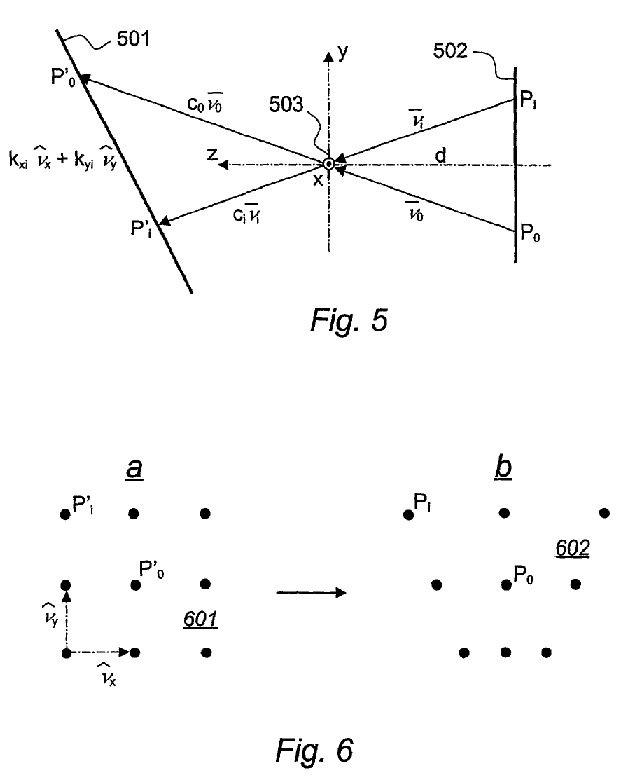

For the sake of clarity, the detailed description below of the invention has been divided into a number of part descriptions. By way of introduction, a coding pattern may be described with reference to FIGS. 1, 2a-d, and 3. As outlined above, this coding pattern may represent positional information, but can also represent other information. After the description of the coding pattern, an example of apparatus that may read the pattern is then described with reference to FIG. 4. The way a pattern can be used for calculating spatial orientation of an apparatus reading the pattern is then described with reference to FIGS. 5 and 6.

Although only one example of a coding pattern will be used in illustrating the invention, it is possible to make use of any other suitable coding pattern. Examples of such patterns are to be found in U.S. Pat. Nos. 5,852,434, 5,051,736, EP-A-0 469 864 (Xerox) as well as assignee's own disclosure WO 00/73983, which is hereby incorporated by reference. Moreover, the coding pattern used below is described in some more detail in assignee's own disclosures PCT/SE00/01895, PCT/SE00/01897 and WO 01/16691 hereby also included by reference.

FIG. 1 shows a part of a product in the form of a sheet of paper 1 that, on its principle surface 2, may be provided with an optically readable position-coding pattern 3. This pattern 3 may enable position determination. The position-coding pattern 3 may include symbols 4 arranged systematically across surface 2 to make its appearance “patterned.” The sheet 1 has an x-coordinate axis and a y-coordinate axis. In this case, position determination can be performed on the entire surface of the sheet 1. In other cases, the surface 2 may constitute a smaller part of the sheet or product. Sheet 1 may be used, for example, to produce an electronic representation of information that may be written or drawn on the surface 2. The electronic representation can be produced by continuously determining, while writing on the surface with a pen (or other writing instrument), the position of the pen on the sheet of paper 10 by reading position-coding pattern 3.

Position-coding pattern 3 includes a virtual raster that may be neither visible to the human eye or detectable directly by an apparatus. The apparatus, in this embodiment, determines positions on the surface, and a plurality of symbols 4 that are each capable of assuming one of four values “1”-“4”. It should be pointed out here that, for the sake of clarity, the position-coding pattern in FIG. 1 has been greatly enlarged. Furthermore, the position-coding pattern is shown on only part of the sheet of paper 1.

Position-coding pattern 3 may be arranged in such a manner that the position of a partial surface on the writing surface may be coded by the symbols on this partial surface. A first and a second partial surface 5a, 5b are indicated by dashed lines in FIG. 1. That part of the position-coding pattern 3 (in this case 3×3 symbols) that may be present on the first partial surface 5a codes a first position, and that part of the position-coding pattern 3 located on the second partial surface 5b codes a second position. The position-coding pattern may be therefore partly common to the adjoining first and second positions. Such a position-coding pattern 3 may be referred to in this application as “floating”.

FIGS. 2a-d show an embodiment of a symbol that can be used in the position-coding pattern according to the present invention. The symbol may include a virtual raster point 6 that may be represented by the intersection between the raster lines, and a marking 7 that may be in the form of a dot. The value of the symbol depends on where the marking may be located. In the example in FIG. 2, there are four possible positions, one on each of the raster lines extending from the raster points. The displacement from the raster point may be equal for all the values. The symbol has the value 10 in FIG. 2a, the value 2 in FIG. 2b, the value 3 in FIG. 2c and the value 4 in FIG. 2d. In other words, there may be four different types of symbols.

Each symbol can thus represent four values “1-4”. This means that the position-coding pattern 3 may be divided into a first position code for the x-coordinate, and a second position code for the y-coordinate. The division may be effected as follows:

| Symbol value | x-code | y-code |
|---|---|---|
| 1 | 1 | 1 |
| 2 | 0 | 1 |
| 3 | 1 | 0 |
| 4 | 0 | 0 |

The value of each symbol may be therefore translated into a first digit, in this case a bit, for the x-code and a second digit, in this case, a bit, for the y-code. In this manner, two completely independent bit patterns are obtained. The patterns can be combined to form a common pattern that may be coded graphically by means of a plurality of symbols according to FIG. 2.

Each position may be coded by a plurality of symbols. In this example, 4×4 symbols may be used to code a position in two dimensions, an x-coordinate and a y-coordinate.

The position code consists of a number series of ones and zeros that have the characteristic that no sequence of four bits appears more than once in the series. The number series may be cyclic, meaning that the characteristic also applies when the end of the series may be connected to its beginning. Thus, a four-bit sequence always has an unambiguously determined position in the number series.

The series may be 16 bits long if it is to have the characteristic described above for sequences of four bits. In this example, however, a series having a length of only seven bits as follows may be used:

“0 0 0 1 0 1 0”.

This series contains seven unique sequences of four bits that codes a position in the series as follows:

| Position in the series | Sequence |
|---|---|
| 0 | 0001 |
| 1 | 0010 |
| 2 | 0101 |
| 3 | 1010 |
| 4 | 0100 |
| 5 | 1000 |
| 6 | 0000 |

For coding the x-coordinate, the number series may be written sequentially in columns across the entire surface to be coded. The coding may be based on the difference or positional displacement between numbers in adjacent columns. The size of the difference may be determined by the position (i.e., the sequence) in the number series, with which the column may be made to begin. More specifically, taking the difference modulo seven between, on the one hand, a number that may be coded by a four-bit sequence in a first column and which may have the value (position) 0-6, and on the other hand, a corresponding number (i.e., the sequence on the same “level”) in an adjacent column, the result will be the same irrespective of where along the two columns the comparison may be made. With the difference between two columns, it may be therefore possible to code an x-coordinate that may be constant for all y-coordinates.

Since each position on the surface may be coded with 4×4 symbols in this example, three differences having the value 0-6) as stated above are available to code the x-coordinate. Coding can then be performed such that, of the three differences, one will always have the value 1 or 2 and the other two will have values in the range 3-6. Consequently, in this particular embodiment, no differences are allowed to be zero in the x-code. In other words, in this example, the x-code may be structured so that the differences will be as follows:

(3-6) (3-6) (1-2) (3-6) (3-6) (1-2) (3-6) (3-6) (1-2) . . .

Each x-coordinate may be therefore coded with two numbers between 3 and 6 and a subsequent number which may be 1 or 2. If three may be subtracted from the high numbers and one from the low, a number in mixed base may be obtained. This number will directly yield a position in the x-direction, from which the x-coordinate can then be determined, as shown in the example below.

By means of the principle described above, it may be possible to code x-coordinates 0, 1, 2 etc. by means of numbers representing three differences. These differences are coded with a bit pattern that may be based on the number series above. The bit pattern can finally be coded graphically by means of the symbols in FIG. 2.

In many cases, when reading 4×4 symbols, a complete number that codes the x-coordinate will not be produced, but parts of two numbers. Since the least significant part of the numbers may be always 1 or 2, however, a complete number can easily be reconstructed.

The y-coordinates are coded according to the same principle. The cyclic number series may be repeatedly written in horizontal rows across the surface to be position-coded. In exactly the same way as for the x-coordinates, the rows are made to begin in different positions i.e., different sequences in the number series. However, for the y-coordinates, use is not necessarily made of differences, but coordinates may be coded with numbers that are based on the starting position of the number series on each row. This may be because, when the x-coordinate for 4×4 symbols has been determined, it may be possible to determine the starting positions in the number series for the rows that are included in the y-code in the 4×4 symbols. In the y-code, the most significant digit may be determined by letting this be the only one that has a value in a specific range. In this example, one row of four may be made to begin in the position 0-1 in the number series to indicate that this row relates to the least significant digit in a y-coordinate, and the other three are made to begin in the position 2-6. In the y-direction, there may be a series of numbers as follows:

(2-6) (2-6) (2-6) (0-1) (2-6) (2-6) (2-6) (0-1) (2-6) . . .

Each y-coordinate may be thus coded with three numbers between 2 and 6 and a subsequent number between 0 and 1. If 1 may be subtracted from the low number and 2 from the high numbers, a position in the y-direction in mixed base, from which it may be possible to determine the y-coordinate directly, may be obtained in the same manner as for the x-direction.

With the above method, it may be possible to code 4×4×2=32 positions in the x-direction. Each such position corresponds to three differences, which gives 3×32=96 positions. Moreover, it may be possible to code 5×5×5 ×2=250 positions in the y-direction. Each such position corresponds to 4 rows, which gives 4×250=1000 positions. Altogether it may be possible to code 96000 positions. Since the x-coding may be based on differences, it may be possible to select the position where the first number series begins. Taking account of the fact that this first number series can begin in seven different positions, it maybe possible to code 7×96000=672000 positions. The starting position of the first number series in the first column may be calculated when the x-coordinate has been determined. The above-mentioned seven different starting positions for the first series may code different sheets of paper or writing surfaces on a product.

With a view to further illustrating the invention according to this embodiment, a specific example follows, which may be based on the described embodiment of the position code.

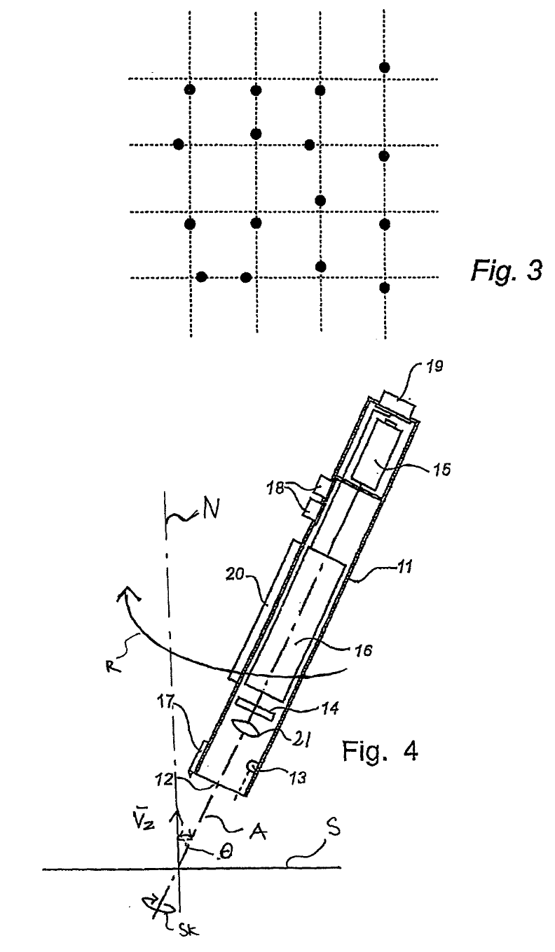

FIG. 3 shows an example of an image with 4×4 symbols that are read by an apparatus for position determination.

These 4×4 symbols have the following values:

4 4 4 2

3 2 3 4

4 4 2 4

1 3 2 4

These values represent the following binary x and y-codes:

| x-code: | y-code: |
|---|---|
| 00000001 | |
| 10100100 | |
| 00000010 | |
| 1100 | 1010 |

The vertical x-sequences code the following positions in the number series: 2 0 4 6. The differences between the columns will be −2 4 2, which modulo 7 gives: 5 4 2, which in mixed base codes the position (5-3)×8+(4-3)×2+(2-1)=16+2+1=19. Since the first coded x-position maybe position 0, the difference that may be in the range 1-2 and that can be seen in the 4×4 symbols may be the twentieth such difference. Since, furthermore, there may be a total of three columns for each such difference and there may be a starting column, the vertical sequence furthest to the right in the 4×4 x-code belongs to the 61st column in the x-code (3×20+1=61) and the one furthest to the left belongs to the 58th.

The horizontal y-sequences code the positions 0 4 1 3 in the number series. Since these series begin in the 58th column, the starting position of the rows may be these numbers minus 57 modulo 7, which yields the starting positions 6 3 0 2. Translated into digits in the mixed base, this will be 6-2, 3-2, 0-0, 2-2=4 1 0 0, where the third digit may be the least significant digit in the number in question. The fourth digit may be then the most significant digit in the next number. In this case, it must be the same as in the number in question. An exception may be when the number in question consists of the highest possible digits in all positions. It is then apparent that the beginning of the next number is one greater than the beginning of the number in question.

The position of the four-digit number will then be 0×50+4×10+1×2+0×1=42 in the mixed base.

The third row in the y-code may be the 43rd that has the starting position 0 or 1, and, since there are four rows in all on each such row, the third row may be number 43×4=172.

In this example, the position of the uppermost left corner for the 4×4 symbol group may be thus (58,170).

Since the x-sequences in the 4×4 group begin on row 170, the x-columns of the entire pattern begin in the positions of the number series ((2 0 4 6)-169) modulo 7=1 6 3 5. Between the last starting position (5) and the first starting position, the numbers 0-19 are coded in the mixed base, and, by adding up the representations of the numbers 0-19 in the mixed base, the total difference between these columns may be obtained. A primitive algorithm for carrying this out may generate these twenty numbers and directly add up their digits. The resulting sum may be called s. The sheet of paper 10 or similar writing surface may then be identified by (5−s) modulo 7.

In the example above, an exemplary embodiment has been described, in which each position may be coded with 4×4 symbols, and a number series with 7 bits may be used. Of course, this is only an example. Positions can be coded with a greater or smaller number of symbols. The number of symbols need not be the same in both directions. The number series can be of different length and need not be binary, but may be based on another base. Different number series can be used for coding in the x-direction and coding in the y-direction. The symbols can have different numbers of values.

In the example above, the marking maybe a dot but may, of course, have a different appearance. For example, it may consist of a dash that begins in the virtual raster point and extends from it to a defined position.

Further, in this example, the symbols within a square partial surface are used for coding a position. The partial surface may have a different shape, such as hexagon. The symbols need not be arranged in rows and columns at an angle of 90° to each other but can also be arranged in some other manner.

For the position code to be detectable, the virtual raster must be determined. This can be performed by studying the distance between different markings. The shortest distance between two markings must derive from two neighboring symbols having the value 1 and 3 so that the markings are located on the same raster line between two raster points. When such a pair of markings has been detected, the associated raster points can be determined with knowledge of the distance between the raster points and the displacement of the markings from the raster points. Once two raster points have been located, additional raster points can be determined by measuring distances to other markings and with knowledge of the distance of the raster points from one another.

An embodiment of an apparatus for position determination, the spatial relationship of which to a surface can be determined, is shown schematically in FIG. 4. The apparatus may include a casing 11 having approximately the shape of a pen. In one short side of the casing there may be an opening 12. The short side may be configured to bear against or be held a short distance from a surface S on which position determination may be to be carried out. In the Figure, a normal direction \overline{v}_{z} to the surface S and an axis A extending through the apparatus are indicated. The axis A forms an angle of inclination, or tilt, θ to the normal direction \overline{v}_{z}.

In the exemplary embodiment, the casing 11 contains essentially an optics part, an electronics part, and a power supply. The optics part may include at least one light emitting diode 13 for illuminating the surface to be imaged and a light-sensitive area sensor 14, such as a CCD or CMOS sensor, for recording a two-dimensional image. The apparatus may also include a lens system. The apparatus may also include a lens system including a schematically illustrated lens 21. The power supply to the apparatus may be obtained from a battery 15 that may be mounted in a separate compartment in the casing 11.

The electronics part may include an image-processing device 16 for determining a position on the basis of the image recorded by the sensor 14 and, more specifically, a image processor with a processor that may be programmed to read images from the sensor and to carry out position determination on the basis of these images.

In this embodiment, the apparatus may also include a pen point 17 for ordinary pigment-based writing on the surface. The pen point 17 may be extendable and retractable so that the user can control whether or not it is to be used. In certain applications, the apparatus need not have a pen point at all or comprise a fixed, nonretractable, pen point. Moreover, the device may comprise a plurality of retractable pen points, each having, e.g., a different color.

Moreover, the apparatus may include buttons 18 for controlling and activating the apparatus. It also may include a transceiver 19 or similar device to enable wireless transmission, for example, using IR light or radio waves, of information to and from the apparatus. The apparatus can also include a display 20 for showing positions or recorded information.

Applicant's International Patent application 9604008-4 (incorporated herein by reference) describes a device for recording text. This device can be used for position determination if programmed in a suitable way. If it is to be used for pigment-based writing, it may also have a pen point.

The device can be divided into various physical casings, a first casing containing components required for capturing images of the position-coding pattern and for transferring them to components that are located in a second casing and carry out position determination on the basis of the recorded image or images.

As mentioned above, position determination may be carried out by a processor that may therefore have software to locate and decode the symbols in an image and to determine positions on the basis of the codes thus obtained. A person skilled in the art, starting from the example above, may design software that performs position determination on the basis of an image of part of a position-coding pattern. Further, a person of skill in the art will recognize that the image processor may be a variety of components including such as one or several computers programmed with image processing capabilities, a digital signal processing unit, or a specialized IC. Further, the processor may be located at the same site as the apparatus or remotely located and in communication with the apparatus through a variety of transmission media.

In the embodiment above, the pattern may be optically readable and the sensor may be therefore optical. As mentioned above, the pattern can be based on a parameter other than an optical parameter. Obviously, in that case the sensor must be of a type which can read the parameter in question. Examples of such parameters are of chemical, acoustical or electromagnetic character, e.g. resistance, capacitance and inductance. In the embodiment above, the raster is a rectangular grid. It can also have other forms, i.e. non-rectangular.

In the embodiment above, the raster may be a grid. It can also have other forms. Further, in the embodiment above, the longest possible cyclic number series may be not used. Thus, there may be a certain amount of redundancy that can be used, for example, to check the rotation of the group of symbols read.

With reference to FIGS. 5 and 6, an explanation follows of how a grid of markings, or dots, may be distorted on image formation and how this distortion may be used for calculating the spatial orientation of an apparatus reading the pattern or, more correctly, the relative spatial orientation between the patterned surface and the reading apparatus.

The actual calculations are performed in processing means, such as those discussed above in connections with FIG. 4, that is a processor within the device itself. It is also feasible to perform the calculations in an external processor connected to the reading device. The software which performs the calculations is written in accordance with the mathematical expressions to follow and it is assumed that the person skilled in the art will choose suitable tools for performing such programming. The software may be present, or stored, in any form known in the art, such as any volatile or non-volatile memory units capable of being connected to the processor, such as a diskette or a CD-ROM, as well as propagated signals such as the stream of bits that represent Internet transmission of packets or the carrier waves that are transmitted to satellites.

FIG. 6a shows schematically the pattern 601 as it appears when applied to a surface. The pattern may be preferably in the form of such a position-coding pattern as is described above in connection with FIGS. 1-3. While it may be true that, in the patterns used as examples previously, a plurality of the markings are displaced in relation to an orthogonal raster, these displacements are assumed to be relatively small and thus of minor significance in this embodiment. The displacements may also, however, be part of a larger plurality of predetermined vectors which may also be incorporated in the calculations.

In the discussion to follow, it is assumed that the sensor (i.e. sensor 14 in FIG. 4) is arranged such that its normal direction is parallel with the direction of extension of the device. The person skilled in the art may adapt the calculations to allow for other relations between the sensor normal direction and the device.

The points in the square grid, as illustrated in FIG. 6a, are imaged through a lens 503 on the surface 502 of a sensor located in the reading apparatus. The pattern 602 on the sensor surface, as shown in FIG. 6b, may be distorted because the relative spatial orientation between the reading apparatus and the patterned surface may be not orthogonal.

In this case, the pattern may be characterized in that inherent stretches are described by the predetermined two-dimensional vectors

{a:a=kₓᵢ\hat{x}+k_{yi}ŷ}

where kₓᵢ,k_{yi} are integers and \hat{x},ŷ are two-dimensional base vectors. This pattern may be compared with the distorted image on the sensor surface.

In order to model the image formation through the lens system, a coordinate system may be selected that is fixed in relation to the sensor and the lens and the lens may be located at the origin. It may be assumed that all the light rays from the surface to the sensor pass unrefracted through the origin. The degrees of freedom of the model are the distance to and the orientation of the patterned surface.

A point P₀ on the sensor may be selected. The stretch from P₀ to the lens may be defined by the vector \overline{v}₀. In the same manner, a vector \overline{v}ᵢ belonging to the point Pᵢ may be defined. Given this model of image formation, a vector \overline{v}ₖ from the origin to the point P₀ in the image on the sensor will be parallel to the vector \overline{v}′ₖ from the origin to the corresponding point P′₀ on the patterned surface:

\overline{v}_{′k}=cₖvₖ

Two spatial vectors \hat{v}ₓ and \hat{v}_{y} can be introduced that lie in the plane of the patterned surface and constitute base vectors for the grid as it rotates in space. By using the predetermined vectors, the vector from the point P′₀ in the pattern on the surface to any other point P′₀ may be, expressed in \hat{v}ₓ and \hat{v}_{y}, given by:

v′ᵢ−v′₀=kₓᵢ\hat{v}ₓ+k_{yi}\hat{v}_{y}

where the integers kₓᵢ,k_{yi} describe the integer position of a point in the grid relative to P′₀. We can thus describe a relationship according to FIG. 5:

c₀\overline{v}₀+kₓᵢ\hat{v}ₓ+k_{yi}\hat{v}_{y}=cᵢ\overline{v}ᵢ

By introducing the vectors

$${\overline{v}}_{x} ≡ \frac{1}{{c}_{0}} {\hat{v}}_{x} , {\overline{v}}_{y} ≡ \frac{1}{{c}_{0}} {\hat{v}}_{y}$$

the following may be obtained:

$${\overline{v}}_{0} + {k}_{xi} {\overline{v}}_{x} + {k}_{yi} {\overline{v}}_{y} = \frac{{c}_{i}}{{c}_{0}} {\overline{v}}_{i} .$$

An equation for each dimension may be then:

$$\{ \begin{matrix}{v}_{0 x} + {k}_{xi} {v}_{xx} + {k}_{yi} {v}_{yx} = \frac{{c}_{i}}{{c}_{0}} {v}_{ix} \\ {v}_{0 y} + {k}_{xi} {v}_{xy} + {k}_{yi} {v}_{yy} = \frac{{c}_{i}}{{c}_{0}} {v}_{iy} \\ {v}_{0 z} + {k}_{xi} {v}_{xz} + {k}_{yi} {v}_{yz} = \frac{{c}_{i}}{{c}_{0}} {v}_{iz}\end{matrix}$$

Division results in identical right-hand parts:

$$\{ \begin{matrix}\frac{{v}_{0 x}}{{v}_{ix}} + \frac{{k}_{xi}}{{v}_{ix}} {v}_{xx} + \frac{{k}_{yi}}{{v}_{ix}} {v}_{yx} = \frac{{c}_{i}}{{c}_{0}} \\ \frac{{v}_{0 y}}{{v}_{iy}} + \frac{{k}_{xi}}{{v}_{iy}} {v}_{xy} + \frac{{k}_{yi}}{{v}_{iy}} {v}_{yy} = \frac{{c}_{i}}{{c}_{0}} \\ \frac{{v}_{0 z}}{{v}_{iz}} + \frac{{k}_{xi}}{{v}_{iz}} {v}_{xz} + \frac{{k}_{yi}}{{v}_{iz}} {v}_{yz} = \frac{{c}_{i}}{{c}_{0}}\end{matrix}$$

For each point Pᵢ, there may be therefore an equation system of the type:

aₓᵢ+bₓᵢvₓₓ+cₓᵢv_{yx}=a_{yi}+b_{yi}v_{5 xy}+C_{yi}v_{yy}=a_{zi}+b_{zi}v_{xz}+c_{zi}v_{yz} (1)

where the unknowns are:

(vₓₓv_{xy}v_{xz})≡\overline{v}ₓ and (v_{yx}v_{yy}v_{yz})≡\overline{v}_{y.}

If the number of points may be greater than five, there may be a redundant equation system in, for example, vₓₓ, v_{xy}, and v_{yy}:

$$( \begin{matrix}{b}_{x1} & - {b}_{y1} & {c}_{x1} & - {c}_{y1} \\ {b}_{x2} & - {b}_{y2} & {c}_{x2} & - {c}_{y2} \\ ⋮ & ⋮ & ⋮ & ⋮ \\ {b}_{xn} & - {b}_{yn} & {c}_{xn} & - {c}_{yn}\end{matrix} ) ( \begin{matrix}{v}_{xx} \\ {v}_{xy} \\ {v}_{yx} \\ {v}_{yy}\end{matrix} ) = ( \begin{matrix}{a}_{y1} - {a}_{x1} \\ {a}_{y2} - {a}_{x2} \\ ⋮ \\ {a}_{yn} - {a}_{xn}\end{matrix} )$$

The least square method gives vₓₓ, v_{xy}, v_{yx}and v_{yy}, vₓₓ and v_{xy} are inserted into equation (1) and a similar equation system maybe obtained for and v_{xz} and v_{yz} that may be solved by means of the least square method.

The direction of the vectors \overline{v}ₓ and \overline{v}_{y} may be thus known, and in this way the spatial orientation of the pattern read has been determined.

The vectors \overline{v}ₓ and \overline{v}_{y} obtained then give a normal vector to the patterned surface through the cross product \overline{v}_{z}=\overline{v}ₓ×\overline{v}_{y}. The angle θ between the normal vector \overline{v}_{z} and the z axis, that may be fixed in the apparatus, and given by

$$cos θ = \frac{{v}_{zz}}{\vert {\overline{v}}_{z} \vert}$$

Usually, as is known in the art, the orientation of a device such as a pen with respect to the pattern on the surface can be expressed using three numbers: rotation, tilt and skew. The skew is defined as the angle of rotation of the pen around its rotational axis. The tilt angle is the angle the pen extends with respect to a normal vector to the surface and the rotation is the angle of rotation of the pen with respect to the normal vector. A zero tilt implies that the rotation is equal to the skew. These angles are illustrated in FIG. 4, where the normal vector to the surface is denoted N, rotation is denoted R, the tilt is denoted θ and the skew is denoted SK. Note that in FIG. 4, the axis A of the device illustrates a coinciding optical axis and axis of rotation of the device.

In order to calculate rotation, tilt and skew, we begin by noting from above that

$${\overline{v}}_{x} ≡ \frac{1}{{c}_{0}} {\hat{v}}_{x} and {\overline{v}}_{y} ≡ \frac{1}{{c}_{0}} {\hat{v}}_{y}$$

from which equations, c₀ can be calculated.

A vector \overline{v}′₀ extending from the origin to the surface on which the pattern is located, parallel with the vector \overline{v}₀ extending from P₀ to the origin, is given by

\overline{v}′₀=c₀\overline{v}₀

We also know from above that the normal vector to the surface, extending away from the pen, is given by

\hat{v}ₙ=\hat{v}ₓ×v\hat{v}_{y}

Now an equation for the plane of the surface can be calculated. The distance from the origin to the surface is given by

$$h = \frac{{\overline{v}}_{0}^{′} \cdot {\hat{v}}_{n}}{\vert {\hat{v}}_{n} \vert}$$

For each vector \overline{v}ₚ=(xₚ,yₚ,zₚ) from the origin to the plane of the surface the expression

$$h = \frac{{\overline{v}}_{p} \cdot {\hat{v}}_{n}}{\vert {\hat{v}}_{n} \vert}$$

holds, which gives an equation for the plane of the surface:

Pₓxₚ+P_{y}yₚ+P_{z}zₚ+P₀=0

The axis of the pen is assumed to be parallel with the z-axis. Hence, a vector extending from the origin to the surface, parallel with the axis of the pen can be calculated by inserting xₚ=0 and yₚ=0 in the equation for the plane of the surface:

\overline{v}₀ₚ=(0,0,−P₀/P_{z})

The angle between the normal vector and \overline{v}₀ₚ gives the tilt:

$$tilt = {cos}^{- 1} ( \frac{{\overline{v}}_{0 p} \cdot {\hat{v}}_{n}}{\vert {\overline{v}}_{0 p} \vert \cdot \vert {\hat{v}}_{n} \vert} )$$

If the tilt is non-zero, the skew can be calculated. The projection of the normal vector onto the xy-plane gives:

\hat{v}ₙₚ=(vₙₓ,v_{ny},0)

Then the skew is given by the angular deviation from the y-axis:

$$\pm skew = {cos}^{- 1} ( \frac{{\hat{v}}_{np} \cdot ( 0 , 1 , 0 )}{\vert {\hat{v}}_{np} \vert} )$$

where the skew is positive when vₙₓ is positive and negative otherwise.

The projection of the axis of the pen onto the plane of the surface is now obtained by:

\overline{P}ᵥ=(projₓ,proj_{y})

where

projₓ=\overline{v}₀ₚ·\hat{v}ₓ and proj_{y}=\overline{v}₀ₚ·\hat{v}_{y}

The angle between this vector and the vectors of the pattern gives the rotation:

$$rot = \pm {cos}^{- 1} ( \frac{{proj}_{x}}{\vert {\overline{p}}_{v} \vert} )$$

and, if the tilt is zero, we have:

$$rot = \pm {cos}^{- 1} ( \frac{- {v}_{xx}}{\vert {\hat{v}}_{x} \vert} )$$

where a positive y-coordinate implies a positive rotation.

The position of the tip of the pen can be calculated by considering the fact that, when the pen changes orientation, during writing for example, the equation for the plane of the surface will change. By considering such a changing equation for the plane of the surface as a sequence of different planes in which the tip of the pen is located, the position of the tip can simply be found by noting that only one point will be common to all planes: the point of the tip of the pen. This calculation can be performed when there are available at least three different equations for the plane of the surface.

A plane is defined by an equation, as indicated above, by it's coefficients. For a plane i, we have:

(Pₓᵢ,P_{yi},P_{zi},P₀ₗ)

The position of the tip of the pen is given by a system of equations:

$$\{ \begin{matrix}{P}_{x0} x + {P}_{y0} y + {P}_{z0} z + {P}_{00} = 0 \\ {P}_{x1} x + {P}_{y1} y + {P}_{z1} z + {P}_{01} = 0 \\ ⋮ \\ {P}_{xk} x + {P}_{yk} y + {P}_{zk} z + {P}_{0 k} = 0\end{matrix}$$

which can be solved in accordance with any procedure known in the art, yielding the xyz-coordinates, a distance vector, for the tip of the pen.

The exact position of the physical tip of the pen may then be utilized to find the exact displacement between the tip and the position calculated from the position coding pattern, i.e. the center of the images obtained. Such a displacement is inherent and, in essence, unavoidable since the optical axis of the lens system of the pen does not coincide with the writing pen. The displacement is not necessarily known in advance due to mechanical inaccuracies when assembling the pen as well as inaccuracies occurring when performing refill-replacement-actions in the case the pen is equipped with a replaceable refill defining the writing tip. In a pen equipped with multiple tips, for example of different colors, the location of the tip with respect to the sensor will vary for each color. Such variations in tip location can be determined, and accounted for, by way of the present invention.

The calculated displacement is preferably used to synchronize the physical track made by the pen and the digitally recorded track as determined by the center of the images. This is advantageous in that it obviates the need to mechanically measure and calibrate the spatial relation between the tip of the pen and the optical system.

The foregoing description is presented for purposes of illustration and description. It is not exhaustive and does not limit the invention to the precise form disclosed. Modifications and variations are possible in light of the above teachings or may be acquired from practicing the invention. The scope of the invention is defined by the claims and their equivalents.

Concurrently filed with the application for this patent are applications entitled Systems and Methods for Information Storage based on Swedish Application No. 0000947-2, filed Mar. 21, 2000, and U.S. Provisional Application No. 60/207,839, filed May 30, 2000; Secured Access Using a Coordinate System based on Swedish Application No. 0000942-3, filed Mar. 21, 2000, and U.S. Provisional Application No. 60/207,850 filed on May 30, 2000; System and Method for Printing by Using a Position Coding Pattern based on Swedish Application No. 0001245-0, filed on Apr. 5, 2000, and U.S. Provisional Application No. 60/210,651, filed on Jun. 9, 2000; Apparatus and Methods Relating to Image Coding based on Swedish Application No. 0000950-6, filed on Mar. 21, 2000, and U.S. Provisional Application No. 60/207,838, filed on May 30, 2000; Apparatus and Methods for Determining Spatial Orientation based on Swedish Application No. 0000951-4, filed on Mar. 21, 2000, and U.S. Provisional Application No. 60/207,844, filed on May 30, 2000; System and Method for Determining Positional Information based on Swedish Application No. 0000949-8, filed Mar. 21, 2000, and U.S. Provisional Application No. 60/207,885, filed on May 30, 2000; Method and System for Transferring and Displaying Graphical Objects based on Swedish Application No. 0000941-5, filed Mar. 21, 2000, and U.S. Provisional Application No. 60/208,165, filed May 31, 2000; Online Graphical Message Service based on Swedish Application No. 0000944-9, filed Mar. 21, 2000, and U.S. Provisional Application No. 60/207,881, filed May 30, 2000; Method and System for Digitizing Freehand Graphics With User-Selected Properties based on Swedish Application No. 0000945-6, filed Mar. 21, 2000, U.S. Provisional Application No. 60/207,882, filed May 30, 2000; Data Form Having a Position-Coding Pattern Detectable by an Optical Sensor based on Swedish Application No. 0001236-9, filed Apr. 5, 2000, and U.S. Provisional Application No. 60/208,167, filed May 31, 2000; Method and Apparatus for Managing Valuable Documents based on Swedish Application No. 0001252-6, filed Apr. 5, 2000, and U.S. Provisional Application No. 60/210,653 filed Jun. 9, 2000; Method and Apparatus for Information Management based on Swedish Application No. 0001253-4 filed Apr. 5, 2000, and U.S. Provisional Application No. 60/210,652, filed Jun. 9, 2000; Device and Method for Communication based on Swedish Application No. 0000940-7, filed Mar. 21, 2000, and U.S. Provisional Application No. 60/208,166, filed May 31, 2000; Information-Related Devices and Methods based on Swedish Application No. 0001235-1, filed Apr. 5, 2000, and U.S. Provisional Application No. 60/210,647, filed Jun. 9, 2000; Processing of Documents based on Swedish Application No. 0000954-8, filed Mar. 21, 2000, and U.S. Provisional Application No. 60/207,849, filed May 30, 2000; Secure Signature Checking System based on Swedish Application No. 0000943-1, filed Mar. 21, 2000, and U.S. Provisional Application No. 60/207,880, filed May 30, 2000, Identification of Virtual Raster Pattern, based on Swedish Application No. 0001235-1, filed Apr. 5, 2000, and U.S. Provisional Application No. 60/210,647, filed Jun. 9, 2000, and Swedish Application No. 0004132-7, filed Nov. 10, 2000, and U.S. Provisional Application No.______, filed Jan. 12, 2001; and a new U.S. Provisional Application entitled Communications Services Methods and Systems.

The technical disclosures of each of the above-listed U.S. applications, U.S. provisional applications, and Swedish applications are hereby incorporated herein by reference. As used herein, the incorporation of a “technical disclosure” excludes incorporation of information characterizing the related art, or characterizing advantages or objects of this invention over the related art.

In the foregoing Description of Preferred Embodiments, various features of the invention are grouped together in a single embodiment for purposes of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Description of the Preferred Embodiments, with each claim standing on its own as a separate preferred embodiment of the invention.

What is claimed is:

1. A system for determining a three-dimensional spatial relationship between a surface provided with a predetermined pattern and an apparatus, the system comprising:
means for imaging a portion of the pattern;
means for comparing the imaged portion with the predetermined pattern to obtain at least one reference measurement, wherein the reference measurement depends on the orientation of the surface; and
means for determining a spatial relationship expressed in parameters defining the orientation of the surface.

2. The system according to claim 1, wherein the means for comparison includes means for comparing a number of directed stretches in the image and vectors from the predetermined pattern.

3. The system according to claim 2, wherein the means for determining further includes means for calculating vectors using the least square method.

4. The system according to claim 3, wherein the spatial relationship includes a distance vector between the apparatus and the surface.

5. The system according to claim 4, wherein the spatial relationship includes an angle between an axis extending through the apparatus and the surface.

6. The system according to claim 5, wherein the means for comparison includes means for determining a set of parameters defining a vector that, in relation to a plane extending through the apparatus, determines an inclination for the surface.

7. The system according to claim 5, wherein the means for comparison includes means for determining a set of parameters defining a vector, wherein the vector identifies a normal vector for the surface.

8. The system according to claim 5, wherein the means for comparison includes means for determining at least one parameter defining an angular orientation for the imaged pattern about a normal vector.

9. The system according to claim 5, wherein the imaging means includes means for one-dimensional pattern imaging.

10. The system according to claim 5, wherein the imaging means includes means for two-dimensional pattern imaging.

11. The system according to claim 5, wherein the means for comparison comprise means for determining at least one parameter which unambiguously defines at least one of rotation, tilt and skew of the apparatus.

12. The system according to claim 1, wherein the apparatus is hand-held.

13. The system according to claim 12, wherein the apparatus is in the general form of a pen and comprises means for determining the position of a tip of the pen.

14. The system according to claim 1, further including means for wireless communication.

15. An apparatus for position determination, comprising:
a sensor configured to detect an image from one partial surface of a plurality of partial surfaces on a principle surface, wherein the principle surface includes a position-coding pattern; and
an image-processor, in communication with the sensor and configured to:
identify a predetermined plurality of symbols in the image, wherein each symbol is defined by a raster point and at least one marking, wherein the raster point forms part of a raster that extends over the principle surface and wherein the position of the marking in relation to the raster point indicates a value of each symbol;
determine the value of each symbol in the plurality of symbols;
translate the value of each symbol into at least one first digit for the first position code and at least one second digit for the second position code;
obtain a first coordinate using the first position code and a second coordinate by using the second position code;
compare the detected image with the predetermined pattern;
obtain at least one reference measurement, wherein the reference measurement depends on the orientation of the surface;
determine, using the reference measurement, a three-dimensional spatial relationship expressed in at least the parameters that define the orientation of the surface; and
obtain a third coordinate using the measurement of the spatial relationship.

16. An apparatus according to claim 15, wherein the image-processor is further configured to compare a number of directed stretches in the image with predetermined vectors that follow from the predetermined pattern.

17. An apparatus according to claim 16, wherein the image-processor is further configured to perform calculations according to the least square method.

18. An apparatus according to claim 17, wherein the spatial relationship includes a distance vector between the apparatus and the surface.

19. An apparatus according claim 17, wherein the spatial relationship includes an angle between an axis extending through the sensor and the surface.

20. An apparatus according claim 17, wherein the image-processor is further configured to determine a set of parameters defining a vector that, in relation to a plane extending through the sensor, establish an inclination for the surface.

21. An apparatus according to claim 17, wherein the image-processor is further configured to determine a set of parameters defining a vector, wherein the vector is a normal vector for the surface having the pattern.

22. An apparatus according claim 21, wherein the image-processor is further configured to determine at least one parameter defining an angular orientation for the imaged pattern about a normal vector for the partial surface.

23. An apparatus according to claim 15, wherein the image-processing is further configured for one-dimensional pattern imaging.

24. An apparatus according to claim 15, wherein the image-processing is further configured for two-dimensional pattern imaging.

25. An apparatus according to claim 15, wherein the apparatus is hand-held.

26. An apparatus according to claim 25, wherein the apparatus is in the general form of a pen and comprises means for determining the position of a tip of the pen.

27. An apparatus according to 26, wherein the apparatus includes means for wireless transmission of information.

28. A method for determining a spatial relationship between a surface having a predetermined pattern and an apparatus, the method comprising:
imaging a portion of the pattern;
comparing the imaged portion with the predetermined pattern to obtain at least one reference measurement, wherein the reference measurement depends on the orientation of the surface; and
determining, using the reference measurement, the spatial relationship expressed in at least the parameters defining the orientation of the surface.

29. A method according to claim 28, wherein the predetermined pattern includes predetermined vectors and wherein comparing includes comparing the predetermined vectors to a number of directed stretches in the image portion.

30. A method according to claim 29, wherein detecting includes calculating the spatial relationship using a least square method.

31. A method according to claim 30, wherein calculating the spatial relationship includes calculating a distance between the apparatus and the surface.

32. A method according to claim 30, wherein calculating the spatial relationship includes calculating at least an angle between an axis extending through the apparatus and the surface.

33. A method according to claim 31, wherein comparing further includes determining a set of parameters defining a vector that, in relation to a plane extending through the apparatus, establish an inclination for the surface.

34. A method according to claim 31, wherein comparing further includes determining a set of parameters defining a vector, and wherein the vector is a normal vector for the surface having the pattern.

35. A method according to claim 31, wherein comparing further includes determining at least one parameter defining an angular orientation for the imaged pattern about a normal vector for the partial surface.

36. A method according to claim 31, wherein imaging comprises imaging a one-dimensional pattern.

37. A method according to 36, wherein imaging comprises imaging a two-dimensional pattern.

38. A method of determining information from a principle surface of a product, comprising:
producing an image of one partial surface from a plurality of partial surfaces on the principle surface;
providing a position-coding pattern within the image;
locating a predetermined plurality of symbols in the image, each symbol having a raster point and at least one marking, the raster point forming part of a raster extending over the principle surface, and wherein a value of each symbol indicates a position of the marking in relation to a raster point;
determining the value of each symbol in the plurality of symbols;
translating the value of each symbol into at least one first position code and at least one second position code;
calculating a first coordinate using the first position code and a second coordinate using the second position code;
comparing the detected image with the pattern;
calculating at least one reference measurement, wherein the reference measurement depends on an orientation of the principle surface;
determining, using the reference measurement, a spatial relationship expressed in at least parameters that define the orientation of the principle surface; and
calculating a third coordinate using the determined spatial relationship.

39. A method according to claim 38, wherein comparing further includes comparing a number of directed stretches in the image to predetermined vectors in the predetermined pattern.

40. A method according to claim 39, wherein determining includes calculating the spatial relationship using a least square method.

41. A method according to claim 40, wherein calculating the spatial relationship includes calculating a distance between an imaging sensor and the partial surface having the position-coding pattern.

42. A method according to claim 40, wherein calculating the spatial relationship includes calculating an angle between an axis extending through an imaging sensor and the partial surface having the position-coding pattern.

43. A method according to claim 40, further including determining a set of parameters defining a vector that, in relation to a plane extending through an imaging sensor, establish an inclination for the surface.

44. A method according to claim 40, further including determining a set of parameters defining a vector, wherein the vector is a normal vector for the surface having the pattern.

45. A method according to claim 40, further including determining at least one parameter defining an angular orientation for the imaged pattern about a normal vector for the partial surface.

46. A method according to claim 45, further including determining at least one parameter which unambiguously defines at least one of rotation, tilt and skew of the image sensor.

47. A method according to claim 46, wherein producing the image includes forming one-dimensional pattern imaging.

48. A method according to 47, wherein producing the image includes forming a two-dimensional pattern imaging.

49. A method according to claim 48, wherein the image sensor is in the general form of a pen and the method comprises determining the position of a tip of the pen.

50. A system comprising:
a sensor configured to detect an image from one partial surface of a plurality of partial surfaces on a surface, wherein the surface includes a position-coding pattern; and
a computer-readable medium containing a program including instructions to
identify a predetermined plurality of symbols in the image, wherein each symbol includes a raster point and at least one marking, wherein the raster point forms part of a raster that extends over the surface and wherein a position of the marking in relation to the raster point indicates a value each symbol;
determine the value of each symbol in the plurality of symbols;
translate the value of each symbol into at least one first digit for the first position code and at least one second digit for the second position code;
calculate a first coordinate using the first position code and a second coordinate by using the second position code;
compare the detected image with the position-coding pattern;
calculate at least one reference measurement, wherein the reference measurement depends on an orientation of the surface;
determine, using the reference measurement, a spatial relationship expressed in at least parameters that define the orientation of the surface; and
calculate a third coordinate using the determined spatial relationship.

51. The system of claim 50, wherein the sensor includes a wireless transceiver configured to communicate with the computer.

52. An apparatus for determining a three dimensional spatial relationship between a surface provided with a known pattern, the apparatus comprising:
means for imaging a part of the pattern,
means for comparing the imaged part of the pattern with the predetermined pattern, at least one reference measurement being obtained, which depends on the orientation of the surface,
means for determining, by means of the reference measurement, the spatial relationship expressed in at least the parameters which define the orientation of the surface.

53. A system for determining a three dimensional spatial relationship between a surface containing a known pattern and an apparatus for reading the pattern, the system comprising:
a sensor contained in the apparatus and for detecting markings within the pattern; wherein the sensor is configured to detect at least one reference measurement which depends on the orientation of the surface, at least one reference measurement including a measurement of a relationship between at least one raster point and at least one marking; and
a processor for comparing the detected markings with the predetermined pattern, and for determining the spatial relationship based in part upon the reference measurement.

54. The system according to claim 53, wherein the determined spatial relationship includes a distance vector between the surface and a portion of the apparatus.

55. The system according to claim 54, wherein the determined spatial relationship includes an axis of the apparatus.

56. The system according to claim 55, wherein the raster point is virtual.

57. An apparatus according to claim 18, wherein the image processor further includes means for determining at least one parameter which unambiguously defines at least one of a rotation, a tilt and a skew of the apparatus.

58. A method according to claim 31, wherein the comparing further includes determining at least one parameter which unambiguously defines at least one of a rotation, a tilt and a skew of the apparatus.

59. A method according to claim 58, wherein the apparatus is in the general form of a pen and the method further includes determining the position of a tip of the pen.

60. A method comprising:
using an apparatus to capture an image of a patterned surface
using a distortion in the image to calculated a relative spatial orientation between the surface and the apparatus for capturing the image.

61. The method claim 60, wherein said relative spatial orientation includes any one of a rotation, a tilt, a skewing or a distance between the surface and the apparatus.

62. The method claim 61, wherein the apparatus is a digital pen.
